(19) United States
(12) Patent Application Publication
(10) Pub. No.: US 2023/0171174 A1
(43) Pub. Date: Jun. 1, 2023

(54) DETECT NETWORK FAULT POINT FOR VIRTUAL MACHINES

(71) Applicant: International Business Machines Corporation, Armonk, NY (US)

(72) Inventors: Zhi Chang, BaoDing City (CN); Gang Tang, Nanjing (CN); Xiang Juan Meng, Beijing (CN); Xin Huang, Shanghai (CN); Dong Ma, Beijing (CN)

(21) Appl. No.: 17/536,245

(22) Filed: Nov. 29, 2021

(51) Int. Cl. H04L 43/0823; G06F 9/455

(52) U.S. Cl. CPC H04L 43/0823; G06F 9/45533

(57) ABSTRACT

An approach is provided in which the approach constructs a detection packet that includes a time to live indicator. The approach sends the detection packet from a virtual machine to one of multiple virtual network devices, wherein the virtual network device recognizes the detection packet based on the time to live indicator. The approach determines a network fault point based on receiving a notification packet from one of the multiple virtual network devices, and reports one of the multiple network interface devices that causes the network fault point.

### BACKGROUND

Cloud computing provides an on-demand availability of computer system resources, such as data storage (cloud storage) and computing power. Cloud computing relies on resource sharing to achieve coherence and economies of scale, and often has functions distributed over multiple data center locations.

Network virtualization is the process of combining hardware and software network resources and network functionality into a single, software-based administrative entity referred to as a virtual network. Network virtualization involves platform virtualization that is often combined with resource virtualization. A virtual network device is a virtual device that is managed by a virtual network driver and is connected to a virtual network through a hypervisor using logical domain channels (LDCs).

### BRIEF SUMMARY

According to one embodiment of the present disclosure, an approach is provided in which the approach constructs a detection packet that includes a time to live indicator. The approach sends the detection packet from a virtual machine to one of multiple virtual network devices, wherein the virtual network device recognizes the detection packet based on the time to live indicator. The approach determines a network fault point based on receiving a notification packet from one of the multiple virtual network devices, and reports one of the multiple network interface devices that causes the network fault point.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a fault point program determining virtual network device faults in a system;

FIG. 4 is an exemplary diagram depicting a detection packet with a customized time to live (TTL) indicator field;

FIG. 5 is an exemplary diagram depicting a compute node that shows several components of devices in system 390;

FIG. 6 is an exemplary flowchart showing steps taken by the virtual machine to construct detection packets and receive notification packets;

FIG. 7 is an exemplary flowchart showing steps taken by a virtual network device to receive and process a detection packet;

FIG. 8 is an exemplary diagram depicting detection packets and notification responses iteratively sent between virtual machine 300 and virtual network devices 350 in a properly functioning system 390;

FIG. 9 is an exemplary diagram depicting a continuation FIG. 8's detection packets and notification responses iteratively sent between virtual machine 300, virtual network devices 350, and physical network interface device 360; and

FIG. 10 is an exemplary diagram depicting recorded times of a properly functioning system 390 and recorded times showing a network fault in system 390.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

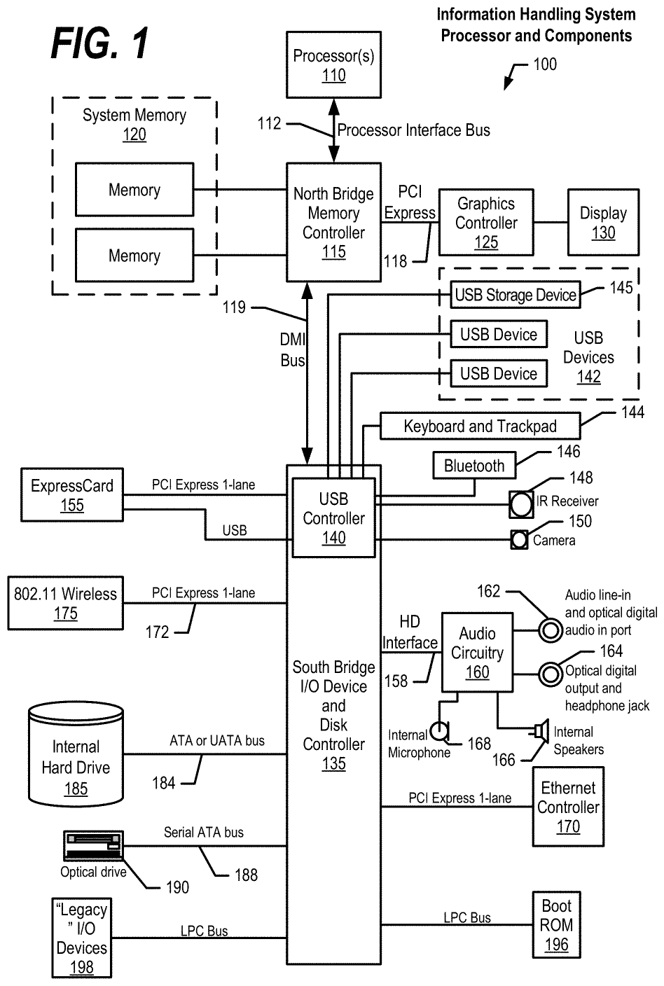

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wirelessly communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

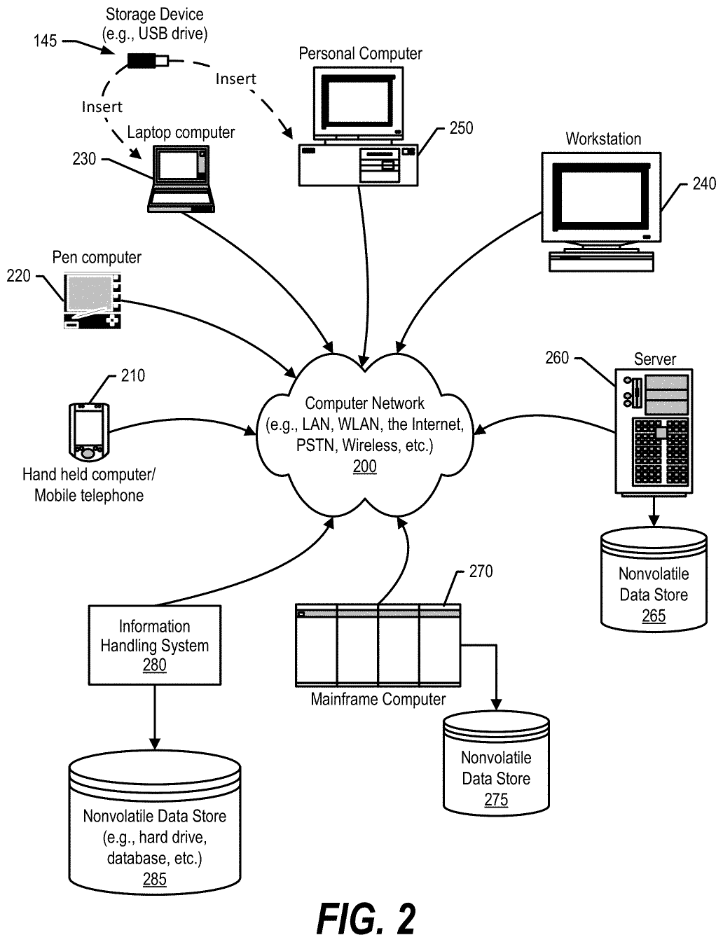

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, virtual network devices are virtual devices that are managed by virtual network drivers and are connected to a virtual network. A challenge found is that troubleshooting network issues between the virtual network devices in cloud networking is complex and requires a deep understanding of network I/O paths to accurately locate network problems. In addition, troubleshooting virtual network devices requires an extensive amount of time due to the long network I/O paths and complex rules. Furthermore, today's virtual network device approaches are inflexible due to different network implementations and topologies.

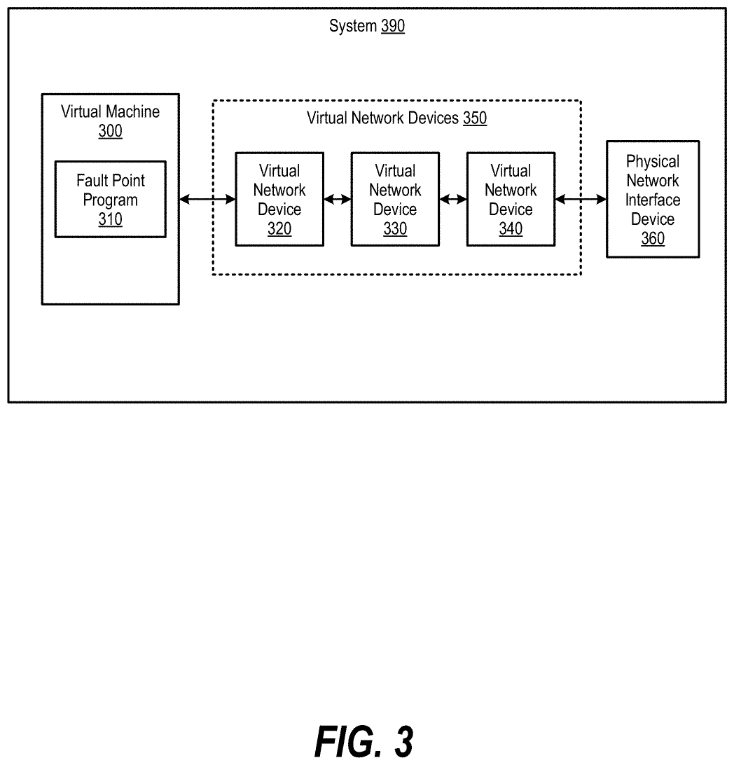

FIGS. 3 through 8 depict an approach that can be executed on an information handling system that constructs a special detection packet and sends the detection packet from a virtual machine to virtual network devices. The virtual network devices recognize the detection packet and determine whether to forward or reply according to a custom time to live (TTL) field in the special packet. The virtual machine receives notification messages to determine the virtual network device path and detect network faults.

FIG. 3 is an exemplary diagram depicting a fault point program determining virtual network device faults in a system. System 390 includes virtual machine 300, virtual network devices 350, and physical network interface device 360. Virtual machine 300 includes fault point program 310. Fault point program 310 constructs a series of detection packets and evaluates responses/notifications from virtual network devices 320, 330, 340, and physical network interface device 360 to determine whether network faults are present.

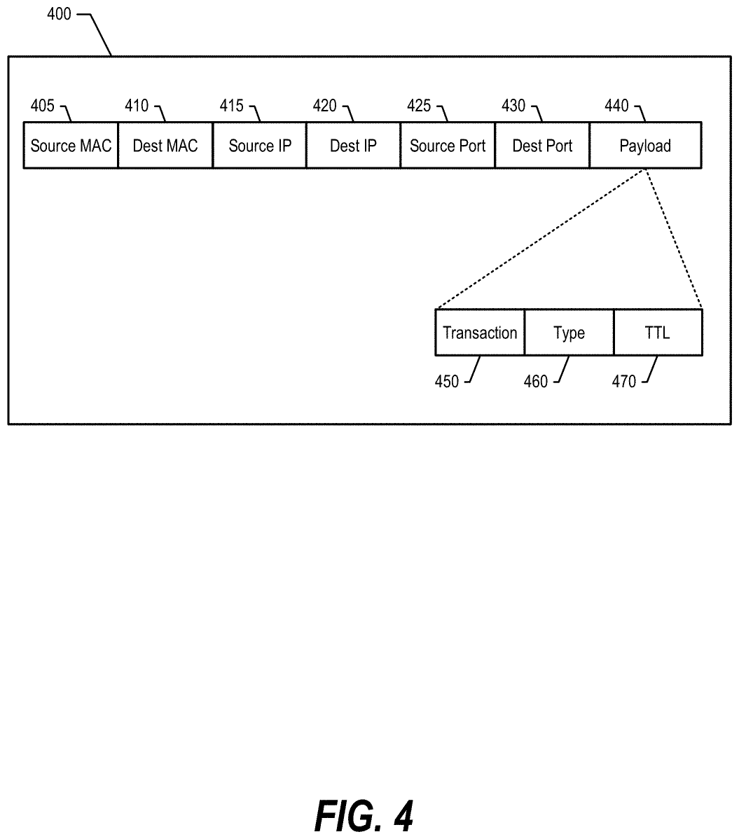

Fault point program 310 generates a detection packet that includes a time to live indicator (see FIG. 4 and corresponding text for further details). In one embodiment, during a packet receiving process of virtual network devices 350, virtual network devices 350 i) recognize the detection packets; ii) decrease the time to live indicator; and iii) determine whether the decreased time to live indicator equals zero. When the decreased time to live indicator equals zero, the respective virtual network device sends a notification back to virtual machine 300.

However, when the decreased time to live indicator does not equal zero, then the respective virtual network device forwards the detection packet to the next virtual network device. For example, virtual machine 300 sends the detection packet to virtual network device 320. Virtual network device 320 decreases the embedded time to live indicator and either a) sends a notification back to virtual machine 300 of the decreased time to live indicator equals zero, or b) replaces the time to live indicator with the decreased time to live indicator in the detection packet and forwards the detection packet to virtual network device 330.

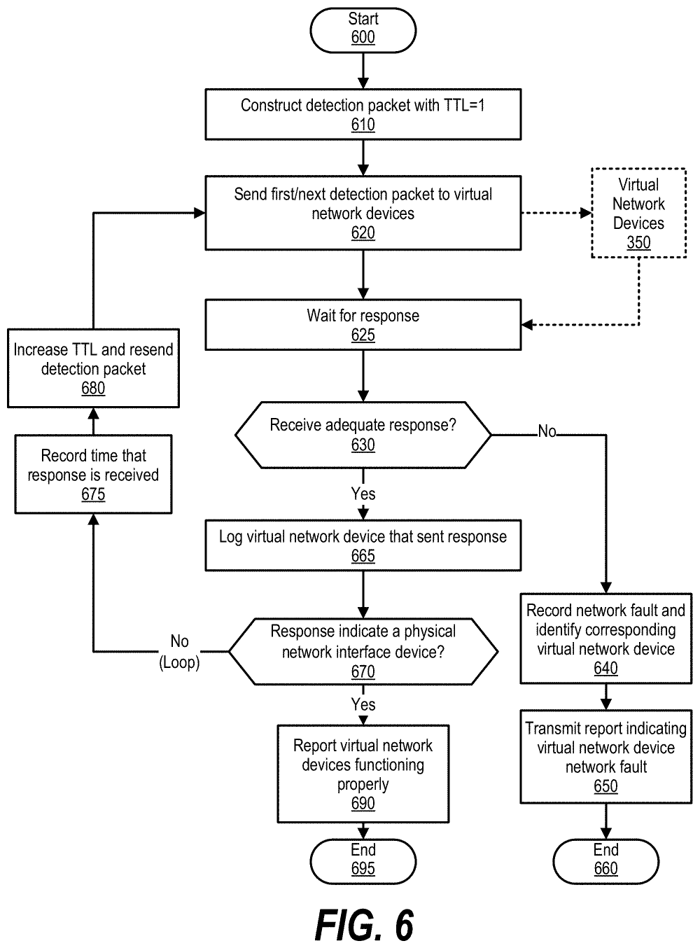

Fault point program 310 iteratively sends detection packets and receives notifications until a fault is detected or determines that virtual network devices 350 are functioning properly (see FIGS. 6 through 9 and corresponding text for further details). When the detection packet eventually reaches physical network interface device 360, physical network interface device 360 constructs a notification packet with a special time to live indicator (e.g., 100) and sends the notification packet back to virtual machine 300. At this point, fault point program 310 uses the special time to live indicator to determine that a physical network interface device is reached.

In one embodiment, the steps discussed above performed by the packet receiving process are performed instead by a packet output process of the virtual network interface devices 350.

FIG. 4 is an exemplary diagram depicting a detection packet with a customized time to live (TTL) indicator field. Detection packet 400 includes source MAC 405, destination MAC 410, source IP 410, destination IP 420, source port 425, destination port 430, and payload 440.

Payload 440 includes transaction ID field 450, type field 460, and TTL indicator field 470. In one embodiment, type response 460 is set to 1 for a response or 0 for a notification. As discussed herein, fault point program 310 iteratively increases TTL indicator field 470 as it receives notifications from virtual network devices 350 and virtual network devices 350 decrease TTL indicator field 470 as detection packet 400 traverses through system 390.

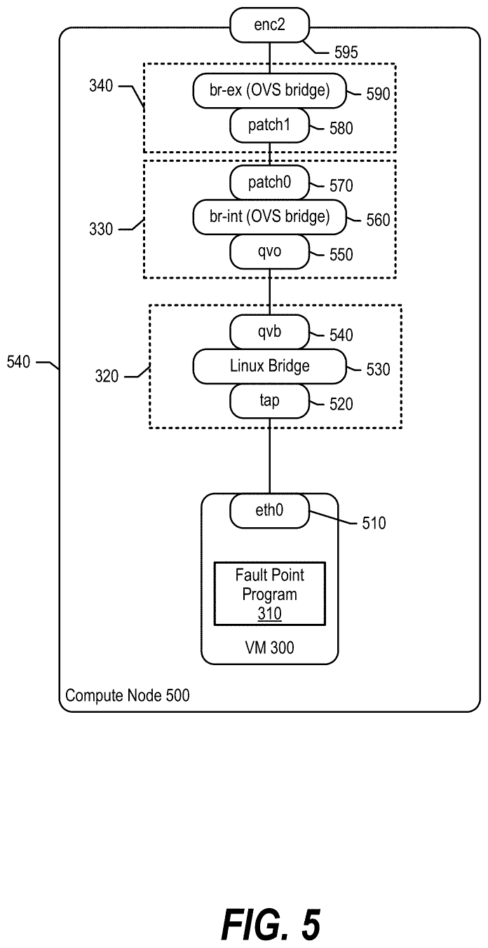

FIG. 5 is an exemplary diagram depicting a compute node that shows several device components in system 390. Compute node 500 shows virtual machine 300 and fault point program 310. Virtual machine 300 uses eth0 510 (Ethernet port) to send and receive packets to virtual network devices 350.

Virtual network device 320 includes tap 520, Linux bridge 530, and qvb 540. Tap 520 is a virtual network kernel driver that implements Ethernet devices and operates at the Ethernet framework level. Tap 520 provides an Ethernet “tap”, which is used to communicate by accessing the Ethernet framework. Linux bridge 530 is a layer 2 data exchange device based on the kernel, and its role is similar to a second-level switch. Qvb 540 and qvo 550 are a VETH (virtual Ethernet) interface pair.

Virtual network device 330 includes qvo 550, integration bridge (br-int) 560, and patch 0 570. Br-int 560 functions as a virtual switch. Patch 0 570 and patch 1 580 are a VETH (virtual Ethernet) interface pair.

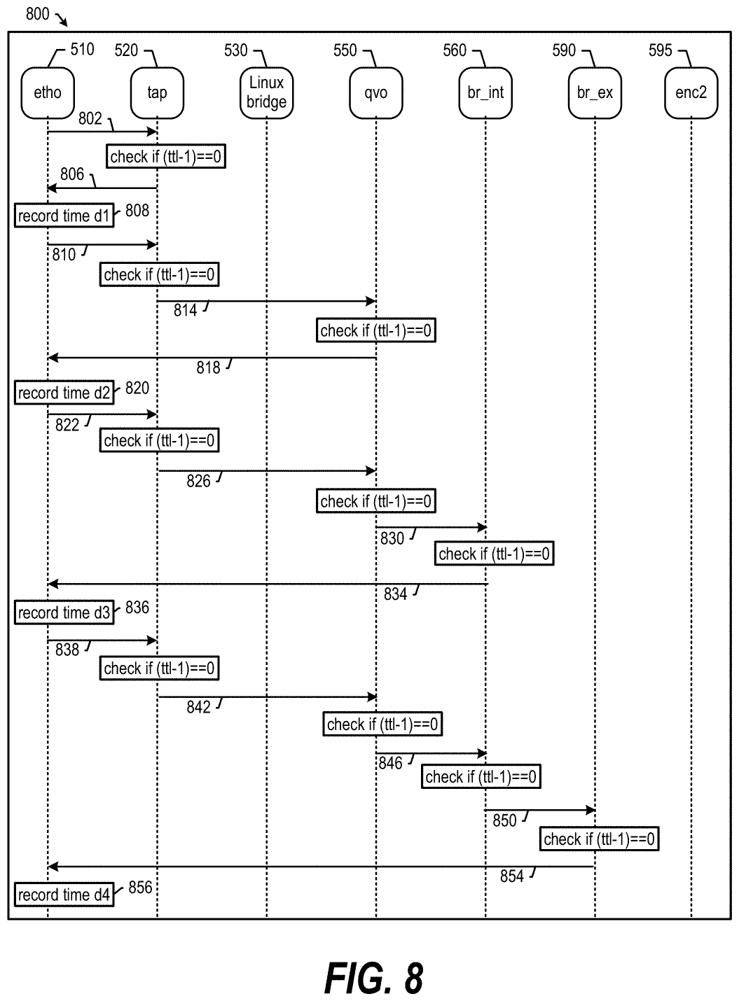

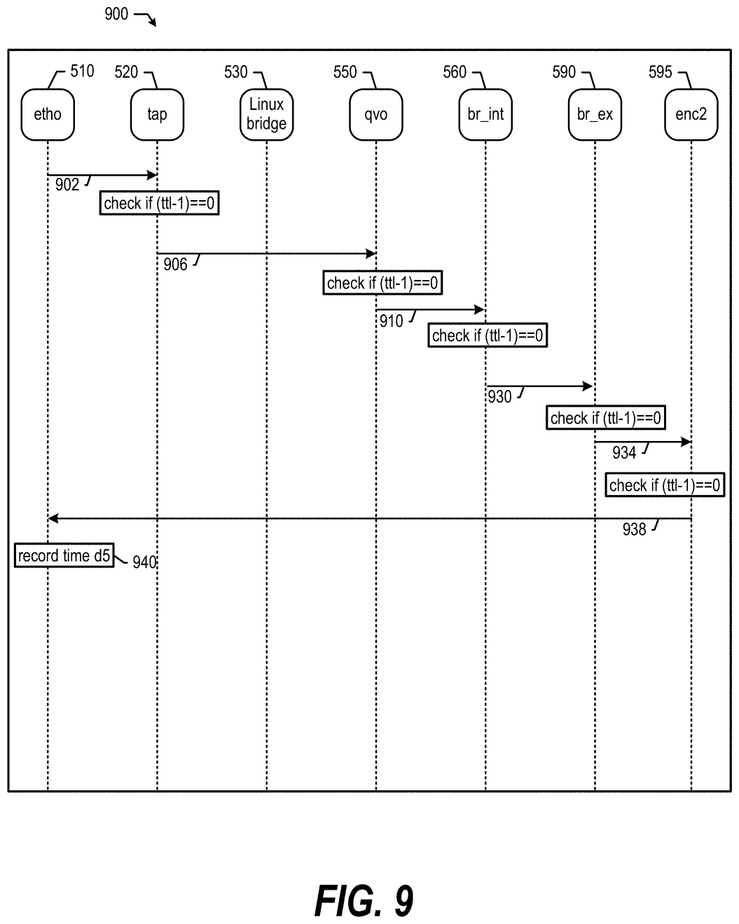

Virtual network device 340 includes patch1 580 and external bridge (br-ex) 590. BR-ex 590 is an OpenvSwitch bridge and connects to the external network. Physical network interface device 360 includes enc2 595, which is a physical ethernet card and connects to the external network. As shown in FIGS. 8 and 9, virtual machine 300 iteratively sends detection packets through compute node 500 to determine whether network faults exist and which virtual network device is causing the network fault.

FIG. 6 is an exemplary flowchart showing steps taken by the virtual machine to construct detection packets and receive notification packets. FIG. 6 processing commences at 600 whereupon, at step 610, the process constructs a detection packet and sets TTL=1. At step 620, the process sends the first detection packet to a virtual network device directly connected to virtual machine 300. At step 625, the process waits for response.

The process determines as to whether virtual machine 300 received an adequate response (e.g., within a predetermined time window) from one of virtual network devices 350 (decision 630). If virtual machine 300 did not receive an adequate response, then decision 630 branches to the ‘no’ branch whereupon, at step 640, the process records a network fault and identifies a corresponding virtual network device, such as based on the virtual network device corresponding to the most recent response from step 665 discussed below. At step 650, the process transmits a report indicating the virtual network device network fault and FIG. 6 processing thereafter ends at 660.

On the other hand, if virtual machine 300 receives an adequate response, then decision 630 branches to the ‘yes’ branch. At step 665, the process logs the virtual network device that sent the response, and determines as to whether the response is from a physical network interface device, such as whether the response includes a custom TTL as discussed herein (decision 670). If the response does not indicate a physical network interface device, then decision 670 branches to the ‘no’ branch which loops back to record the time that the response is received.

At step 680, the process increases the TTL from the last transmitted packet and sends the new detection packet to the virtual network device (step 620). This looping continues until the notification response indicates a physical network interface device, at which point decision 670 branches to the yes' branch exiting the loop. At step 690, the process reports virtual network devices 350 as functioning properly and FIG. 6 processing thereafter ends at 695.

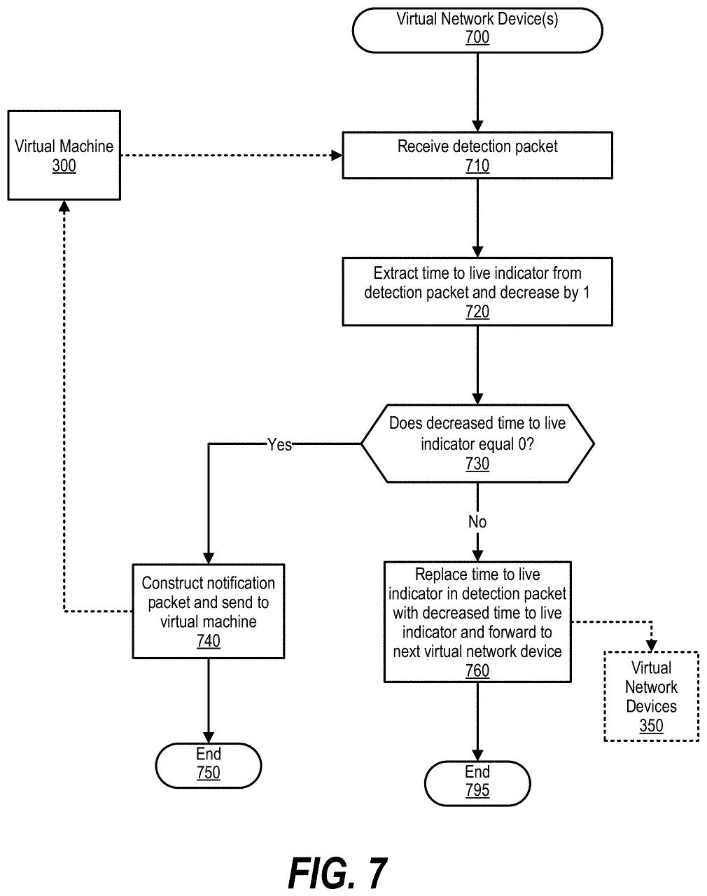

FIG. 7 is an exemplary flowchart showing steps taken by a virtual network device to receive and process a detection packet. FIG. 7 processing commences at 700 whereupon, at step 710, the process receives a detection packet from virtual machine 300 (or other virtual network devices 350 as discussed herein). At step 720, the process extracts a time to live indicator from the detection packet and decreases the time to live indicator by 1.

The process determines as to whether the decreased time to live indicator equals 0 (decision 730). If the decreased time to live indicator equals 0, then decision 730 branches to the ‘yes’ branch. At step 740, the process constructs a notification packet and sends the notification packet to virtual machine 300. FIG. 7 processing thereafter ends at 750.

On the other hand, if the decreased time to live indicator does not equal zero, then decision 730 branches to the ‘no’ branch. At step 760, the process replaces the time to live indicator in the received detection packet with the decreased time to live indicator and forwards the detection packet with the decreased time to live indicator to a next one of virtual network devices 350. FIG. 7 processing thereafter ends at 795.

FIG. 8 is an exemplary diagram depicting detection packets and notification responses iteratively sent between virtual machine 300 and virtual network devices 350 in a properly functioning system 390. Virtual machine 300 (fault point program 310) begins by constructing a detection packet with transaction ID=1, type=0 and TTL=1, and sends detection packet 802 from eth0 510 to tap 520. Tap 520 receives detection packet 802 and recognizes it by its udp src 425 and udp dst port 430. Tap 520 mutates the TTL field 470 to TTL-1 and checks whether TTL equals 0. At this point, the decreased TTL equals 0 and tap 520 constructs a detection packet with transaction ID=1, type=1, TTL=0, eth0's mac address and eth0's IP address. Then the output function of tap 520 sends notification packet 806 to eth0 510.

Virtual machine 300's fault point program 310 receives notification packet 806 and records time d1 808. Because the first detection packet 802's TTL equaled 1, fault point program 310 sends detection packet 810 with transaction ID=2, type=0 and TTL=2. Tap 520 receives packet 810, mutates the TTL field to TTL-1, which results in 1. As such, tap 520 does not drop packet 810 but transmits the detection packet 814 with transaction ID=2, type=0 and TTL=1 via Linux bridge 530 to qvo 550.

Qvo 550 receives detection packet 826 and recognizes it by udp src 425 and udp dst port 430. Qvo 550 mutates the TTL field 470 to TTL-1 and checks whether TTL equals 0, which it does. As such, qvo 550 constructs a notification packet 818 with transaction ID=1, type=1, TTL=0 and sends notification packet 818 to eth0 510.

Virtual machine 300's fault point program 310 receives the notification packet 818 and records time d2 820. Fault point program 310 then sends detection packet 822 with transaction ID=2, type=0 and TTL=3. Tap 520 receives packet 822, decreases TTL by one (now at 2), and checks whether the decreased TTL equals 0, which it does not. Tap 520 sends packet 826 (TTL=2) to qvo 550. Qvo 550 decreases TTL by 1 (now at 1), and checks whether the decreased TTL equals 0, which it does not. As such, qvo 550 sends packet 830 to br_int 560. Br-int 560 decreases TTL by 1 (now at 0), and checks whether the decreased TTL equals 0, which it does. As such, br-int 560 drops the packet and sends notification packet 834 to eth 0 510 where virtual machine 300's fault point program 310 records time d3 836.

Fault point program 310 then sends detection packet 838 with transaction ID=2, type=0 and TTL=4. Tap 520 receives packet 838, decreases TTL by one (now at 3), and determines that the decreased TTL does not equal 0. As such, tap 520 sends packet 842 (TTL=3) to qvo 550. Qvo 550 decreases TTL by 1 (now at 2), and determines that the decreased TTL does not equal 0. As such, qvo 550 sends packet 846 to br_int 560. Br-int 560 decreases TTL by 1 (now at 1), and determines that the decreased TTL does not equal 0. As such, br-int 560 sends packet 850 to br_ex 590. Br_ex 590 decreases TTL by 1 (now at 0) and determines that the decreased TTL equals 0. As such, br_ex 590 drops the packet and sends notification packet 854 to eth0 510 where virtual machine 300's fault point program 310 records time d4 856. Please see FIG. 9 and corresponding text for continued discussion.

FIG. 9 is an exemplary diagram depicting a continuation FIG. 8's detection packets and notification responses iteratively sent between virtual machine 300, virtual network devices 350, and physical network interface device 360.

Continuing from FIG. 8, fault point program 310 sends detection packet 902 with transaction ID=2, type=0 and TTL=5. Tap 520 receives packet 902, decreases TTL by one (now at 4), and determines that the decreased TTL does not equal 0. As such, tap 520 sends packet 906 (TTL=4) to qvo 550. Qvo 550 decreases TTL by 1 (now at 3), and determines that the decreased TTL does not equal 0. As such, qvo 550 sends packet 910 to br_int 560. Br-int 560 decreases TTL by 1 (now at 2), and determines that the decreased TTL does not equal 0. As such, br-int 560 sends packet 930 to br_ex 590. Br_ex 590 decreases TTL by 1 (now at 1) and determines that the decreased TTL does not equal 0. As such, br_ex 590 sends packet 934 to enc2 595. Enc2 595 decreases TTL by 1 (now at 0) and determines that the decreased TTL equals 0. Because TTL=0 at this point, enc2 595 drops the packet and sends notification packet 938 to eth0 510 with a custom TTL indicator (e.g., 100) where fault point program 310 records time d5 (940). Fault point program 310 also determines that notification response 938 is from physical network interface device 360 based on the custom indicator and terminates iterative transmissions of detection packets (see FIG. 6 and corresponding text for further details).

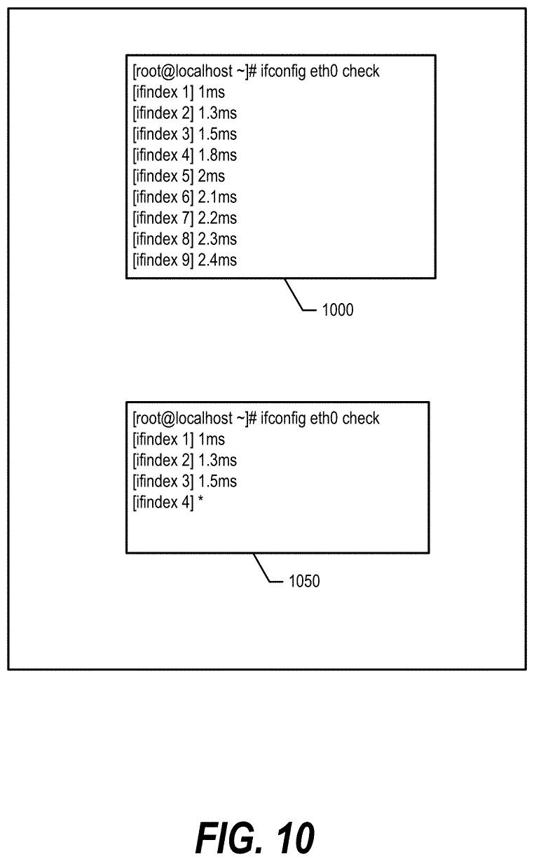

FIG. 10 is an exemplary diagram depicting recorded times of a properly functioning system 390 and recorded times showing a network fault in system 390. Compute node 500 sends detection packets to various virtual network devices discussed herein. As part of the process, fault point program 310 records times it receives notification packets, shown as data 1000. Data 1000 shows that system 390 is operating correctly based on the recorded times.

Data 1050 shows that a response is not received for index 4. Fault point program 310 then maps index 4 to a particular network. In one embodiment, fault point program 310 uses “ifconfig” or “ip a” commands to obtain network interfaces and see the “index” numbers of a network interface (e.g., “20”, “40”, etc.), and ending with a “:”. Fault point program 310 then uses the “index” numbers for mapping and determining which interface is used in the physical host (compute node).

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A computer-implemented method comprising:
constructing a detection packet comprising a time to live indicator;
sending the detection packet from a virtual machine to one of a plurality of virtual network devices, wherein the one of the plurality of virtual network devices recognizes the detection packet based on the time to live indicator;
determining a network fault point based on receiving a notification packet from one of the plurality of virtual network devices; and
reporting one of the plurality of network interface devices that causes the network fault point.

2. The computer-implemented method of claim 1 further comprising:
receiving the detection packet at a first one of the plurality of virtual network devices;
decreasing the time to live indicator by the first virtual network device;
determining whether the decreased time to live indicator equals zero; and
sending the notification packet from the first virtual network device to the virtual machine in response to determining that the decreased time to live indicator equals zero.

3. The computer-implemented method of claim 2 further comprising:
in response to determining that the decreased time to live indicator is greater than zero, sending the detection packet with the decreased time to live indicator from the first virtual network device to a second one of the plurality of virtual network devices.

4. The computer-implemented method of claim 2 wherein a packet receiving process of the first virtual network device further comprises:
decreasing the time to live indicator in response to recognizing the detection packet;
passing the modified packet to a network stack if the decreased time to live indicator is zero; and
in response to determining that the decreased time to live indicator is zero:
dropping the packet and constructing the notification packet; and
sending the notification packet to the virtual machine.

5. The computer-implemented method of claim 2 wherein a packet output process of the first virtual network device further comprises:
decreasing the time to live indicator in response to recognizing the detection packet;
passing the modified packet to a network stack if the decreased time to live indicator is zero; and
in response to determining that the decreased time to live indicator is zero:
dropping the packet and constructing the notification packet; and
sending the notification packet to the virtual machine.

6. The computer-implemented method of claim 1 wherein a packet output process of a physical network interface device further comprises:
in response to recognizing the detection packet, constructing a custom notification packet with a custom time to live indicator; and
sending the custom notification packet to the virtual machine.

7. The computer-implemented method of claim 6 further comprising:
determining, by the virtual machine, a path of the plurality of virtual network devices to the physical network interface device based on receiving the custom notification packet.

8. An information handling system comprising:
one or more processors;
a memory coupled to at least one of the processors;
a set of computer program instructions stored in the memory and executed by at least one of the processors in order to perform actions of:
constructing a detection packet comprising a time to live indicator;
sending the detection packet from a virtual machine to one of a plurality of virtual network devices, wherein the one of the plurality of virtual network devices recognizes the detection packet based on the time to live indicator;
determining a network fault point based on receiving a notification packet from one of the plurality of virtual network devices; and
reporting one of the plurality of network interface devices that causes the network fault point.

9. The information handling system of claim 8 wherein the processors perform additional actions comprising:
receiving the detection packet at a first one of the plurality of virtual network devices;
decreasing the time to live indicator by the first virtual network device;
determining whether the decreased time to live indicator equals zero; and
sending the notification packet from the first virtual network device to the virtual machine in response to determining that the decreased time to live indicator equals zero.

10. The information handling system of claim 9 wherein the processors perform additional actions comprising:
in response to determining that the decreased time to live indicator is greater than zero, sending the detection packet with the decreased time to live indicator from the first virtual network device to a second one of the plurality of virtual network devices.

11. The information handling system of claim 9 wherein a packet receiving process of the first virtual network device further comprises:
decreasing the time to live indicator in response to recognizing the detection packet;
passing the modified packet to a network stack if the decreased time to live indicator is zero; and
in response to determining that the decreased time to live indicator is zero:
dropping the packet and constructing the notification packet; and
sending the notification packet to the virtual machine.

12. The information handling system of claim 9 wherein a packet output process of the first virtual network device further comprises:
decreasing the time to live indicator in response to recognizing the detection packet;
passing the modified packet to a network stack if the decreased time to live indicator is zero; and
in response to determining that the decreased time to live indicator is zero:
dropping the packet and constructing the notification packet; and
sending the notification packet to the virtual machine.

13. The information handling system of claim 8 wherein a packet output process of a physical network interface device further comprises:
in response to recognizing the detection packet, constructing a custom notification packet with a custom time to live indicator; and
sending the custom notification packet to the virtual machine.

14. The information handling system of claim 8 wherein the processors perform additional actions comprising:
determining, by the virtual machine, a path of the plurality of virtual network devices to the physical network interface device based on receiving the custom notification packet.

15. A computer program product stored in a computer readable storage medium, comprising computer program code that, when executed by an information handling system, causes the information handling system to perform actions comprising:
constructing a detection packet comprising a time to live indicator;
sending the detection packet from a virtual machine to one of a plurality of virtual network devices, wherein the one of the plurality of virtual network devices recognizes the detection packet based on the time to live indicator;
determining a network fault point based on receiving a notification packet from one of the plurality of virtual network devices; and
reporting one of the plurality of network interface devices that causes the network fault point.

16. The computer program product of claim 15 wherein the information handling system performs further actions comprising:
receiving the detection packet at a first one of the plurality of virtual network devices;
decreasing the time to live indicator by the first virtual network device;
determining whether the decreased time to live indicator equals zero; and
sending the notification packet from the first virtual network device to the virtual machine in response to determining that the decreased time to live indicator equals zero.

17. The computer program product of claim 16 wherein the information handling system performs further actions comprising:
in response to determining that the decreased time to live indicator is greater than zero, sending the detection packet with the decreased time to live indicator from the first virtual network device to a second one of the plurality of virtual network devices.

18. The computer program product of claim 16 wherein a packet receiving process of the first virtual network device further comprises:
decreasing the time to live indicator in response to recognizing the detection packet;
passing the modified packet to a network stack if the decreased time to live indicator is zero; and
in response to determining that the decreased time to live indicator is zero:
dropping the packet and constructing the notification packet; and
sending the notification packet to the virtual machine.

19. The computer program product of claim 15 wherein a packet output process of a physical network interface device further comprises:
in response to recognizing the detection packet, constructing a custom notification packet with a custom time to live indicator; and
sending the custom notification packet to the virtual machine.

20. The computer program product of claim 19 wherein the information handling system performs further actions comprising:
determining, by the virtual machine, a path of the plurality of virtual network devices to the physical network interface device based on receiving the custom notification packet.
